(19) United States
(12) Patent Application Publication
(10) Pub. No.: US 2016/0133109 A1
(43) Pub. Date: May 12, 2016

(54) OBJECT LOCATOR SYSTEM

(71) Applicant: Ryan LAMANNA, Pickering (CA)

(72) Inventor: Ryan Lamanna, Pickering (CA)

(73) Assignee: Ryan LAMANNA, Ontario (CA)

(21) Appl. No.: 14/896,036

(22) PCT Filed: Jun. 5, 2013
(86) PCT No.: PCT/CA2013/050432

§ 371 Date: Dec. 4, 2015

(51) Int. Cl. G08B 21/18

(52) U.S. Cl. CPC G08B 21/18

(57) ABSTRACT

An object locator system comprises a transmitter comprising circuitry to generate and emit a radio frequency interrogation signal representing one of a plurality of unique codes, a plurality of receivers each recognizing one of the plurality of unique codes and each comprising an audible indicator triggered by recognition of the unique code in the interrogation signal, and a dry erase surface coupled to the transmitter. The dry erase surface may be coupled to the transmitter through a moveable panel. The panel can be coupled to a casing of the transmitter. An alternate mechanism for coupling the dry erase surface to the transmitter is through a transmitter docking pad. The front surface area of the transmitter docking pad is greater than the front surface area of the transmitter with at least 20% of the front surface area of the transmitter docking pad covered by the dry erase surface.

### BACKGROUND OF THE INVENTION

1. Field of the Invention

The present invention relates to object locators, and more particularly object locators capable of locating a plurality of objects.

2. Description of the Related Art

Portable objects are prone to misplacement. Searching for misplaced or moving objects has long been a time consuming activity in both the residential, recreational and business/commercial settings. Time is spent searching for both animate and inanimate objects. Inanimate objects include keys, tools, wallets, remote controls for audio/visual electronics, purses, luggage, backpacks, briefcases, bicycles, jewelry, wrist watches, mobile communication devices, cordless land-line phones, sporting equipment, files, books, toys, cameras, eyeglasses, eyeglass cases, personal grooming devices, calculators, clothing accessories and the like. Examples of animate objects include pets and children.

Many solutions have been proposed to decrease the time spent in locating objects. For example, U.S. Pat. No. 4,101,873 (issued 18 Jul. 1978), U.S. Pat. No. 4,476,469 (issued 9 Oct. 1984), U.S. Pat. No. 4,924,219 (issued 8 May 1990), U.S. Pat. No. 5,204,657 (issued 20 Apr. 1993), U.S. Pat. No. 5,294,915 (issued 15 Mar. 1994), U.S. Pat. No. 5,638,050 (issued 10 Jun. 1997), U.S. Pat. No. 5,677,673 (issued 14 Oct. 1997), U.S. Pat. No. 5,680,105 (issued 21 Oct. 1997), U.S. Pat. No. 5,939,981 (issued 17 Aug. 1999), U.S. Pat. No. 6,297,737 (issued 2 Oct. 2001), U.S. Pat. No. 6,535,125 (issued 18 Mar. 2003), U.S. Pat. No. 6,674,364 (issued 6 Jan. 2004), U.S. Pat. No. 7,064,663 (issued 20 Jun. 2006), and US Patent Application Publication Nos. 2006/U.S. Pat. No. 0,038,676 (published 23 Feb. 2006), and 2010/U.S. Pat. No. 0,156,661 (published 24 Jun. 2010) all provide functional solutions in the form of object locator systems.

Generally, these object locator systems comprise a transmitter and one or more receivers, each receiver attached to a targeted object. Each of these object locator systems suffers from one or more of the following three deficiencies. First, many of these object locator system configurations suffer from a lack of scalability due to the use of one button/switch on the transmitter per targeted object such that an object locator system for greater than three or four objects results in a large number and/or overly complex arrangement of buttons/switches on the transmitter causing confusion as to correlation of the buttons/switches and targeted objects, and increasing the probability that a receiver probed by the transmitter is attached to an object other than the intended target object. Furthermore, a lack of scalability can result in increased manufacturing costs and increased repair costs for higher numbers of targeted objects. Second, certain of these object locator systems have an increased maintenance cost due to their power consumption, particularly transmitters comprising a digital alphanumerical display, such as LCD or LED displays. Third, with many of these object locator systems users misplace the transmitter and spend time searching for the transmitter.

Accordingly, there is a continuing need for alternative object locator systems to address one or more of these deficiencies.

### SUMMARY OF THE INVENTION

In an aspect there is provided, an object locator system, comprising:

a transmitter comprising circuitry to generate and emit a radio frequency interrogation signal representing one of a plurality of unique codes, and a graduated multiple-position switch for selecting the one of the plurality of unique codes, the switch moveable from a first position to a second position in the absence of electrical current, each position providing one of the plurality of unique codes;

a plurality of receivers each recognizing one of the unique codes provided by the graduated multiple-position switch and each comprising an audible indicator triggered by recognition of the unique code in the interrogation signal;

a transmitter docking pad having a front surface and a back surface, the front surface of the transmitter docking pad having a greater area than a front surface of the transmitter, more than 20% of the front surface of the transmitter docking pad covered by a dry erase surface compatible with dry erase markers; and the transmitter coupled to the transmitter docking pad.

In another aspect there is provided an object locator system, comprising:

a transmitter comprising circuitry to generate and emit a radio frequency interrogation signal representing one of a plurality of unique codes, and a graduated multiple-position switch for selecting the one of the plurality of unique codes, the switch moveable from a first position to a second position in the absence of electrical current, each position providing one of the plurality of unique codes;

a plurality of receivers each recognizing one of the unique codes provided by the graduated multiple-position switch and each comprising an audible indicator triggered by recognition of the unique code in the interrogation signal; and a dry erase surface coupled to the transmitter.

In another aspect there is provided an object locator system, comprising:

a transmitter comprising circuitry to generate and emit a radio frequency interrogation signal representing one of a plurality of unique codes;

a plurality of receivers each recognizing one of the plurality of unique codes and each comprising an audible indicator triggered by recognition of the unique code in the interrogation signal; and

a dry erase surface coupled to the transmitter.

### BRIEF DESCRIPTION OF THE DRAWINGS

FIG. 1 shows an exploded perspective view of a transmitter;

FIG. 2 shows a front plan view of the transmitter shown in FIG. 1;

FIG. 3 shows a front perspective view of a transmitter docking pad;

FIG. 4 shows the transmitter shown in FIG. 1 coupled to the transmitter docking pad shown in FIG. 3;

FIG. 5 shows an exploded perspective view of a receiver;

FIG. 6 shows a front plan view of the receiver shown in FIG. 5;

FIG. 7 shows a schematic diagram of the circuitry of the transmitter shown in FIG. 1;

FIG. 8 shows a schematic diagram of the circuitry of the receiver shown in FIG. 5; and

FIG. 9 shows a variant of the schematic diagram shown in FIG. 8.

### DETAILED DESCRIPTION OF THE PREFERRED EMBODIMENT

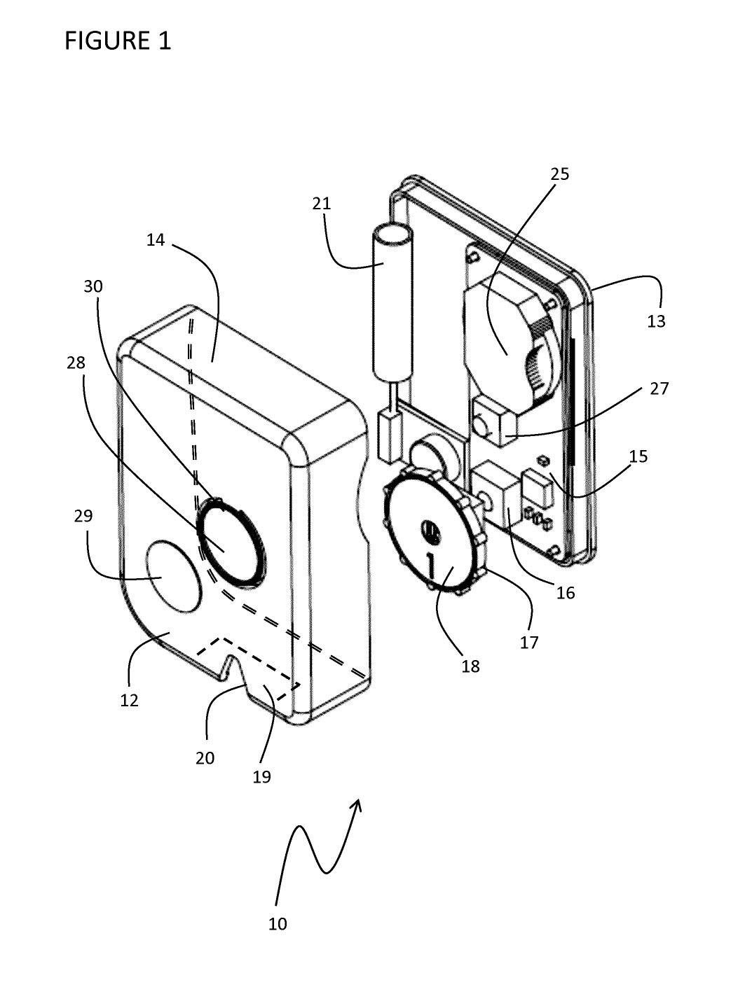

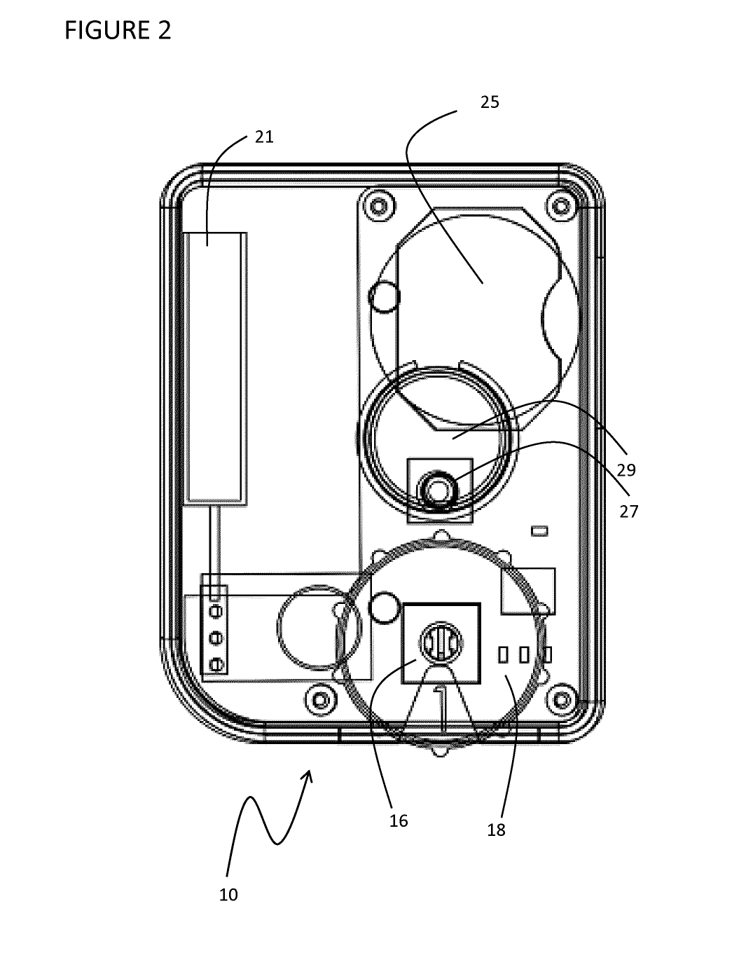

Referring to the drawings, a system for locating objects will be described, the system comprising a transmitter and a plurality of receivers, each receiver coupled to a targeted object. FIG. 1 shows an exploded view of a transmitter 10 and FIG. 2 shows a front plan view of the transmitter. The transmitter 10 comprises a casing with a front surface 12 and a back surface 13 joined by circumferential sides 14 defining an interior cavity between the front surface and the back surface. Electronic components for generating and transmitting a radio frequency (RF) modulated coded signal are mounted within the interior cavity of the casing. The components include: a transmitter printed circuit board 15; a graduated, multiple-position, digital code rotary switch 16; a transmitter microcontroller (not shown); an RF modulator (not shown); a transmitter antenna 21, a transmitter battery 25, and a push-to-make switch 27. Rotary switch 16 provides a plurality of graduated positions, each position corresponding to a code recognized by one of a plurality of receivers. Rotary switch 16 is communicative with the transmitter microcontroller which produces a serial coded waveform based on the selected position of the rotary switch 16. The transmitter microcontroller is communicative with the RF modulator (not shown) that generates an RF carrier frequency and modulates the carrier frequency to represent the serial coded waveform. The modulated carrier frequency signal is transmitted through transmitter antenna 21. The transmitter printed circuit board 15 provides a surface for mechanically supporting a plurality of conductive pathways or tracks for electrically connecting the electronic components of the transmitter including rotary switch 16, transmitter microcontroller (not shown), RF modulator (not shown), transmitter antenna 21, transmitter battery 25, and push-to-make switch 27. Push-to-make switch 27 controls the pathway for transmitter battery 25 to provide power to the other electronic components of the transmitter 10. Transmitter battery 25 is accessible through an aperture (not shown) formed in back surface 13. A transmitter battery cap (not shown) covering the aperture is reversibly coupled to the back surface 13, with removal of the transmitter battery cap allowing access to the transmitter battery 25 for inspection or replacement. Alternatively, in applications where back surface access to the transmitter battery 25 is inconvenient, inspection or replacement of the battery may occur by removal of all or part of the front surface 12.

Transmitter 10 is user controlled by two switches, rotary switch 16 and push-to-make switch 27.

Rotary switch 16 is a multiple position switch, with each position providing a code that is recognized by one of a plurality of receivers. Rotary switch 16 comprises a thumbwheel actuator 17 and a graduated thumbwheel label 18 attached to the actuator 17. Rotary switch 16 is mounted on the transmitter printed circuit board 15 within the interior cavity defined by the transmitter casing. A portion of the thumbwheel actuator 18 extends through a slot 19 formed in the side 14 of the transmitter casing allowing physical access to the thumbwheel actuator 18 to manually select a position of the rotary switch 16. Window 20 formed at the periphery of front surface 12 and aligned with slot 19 allows for visual inspection of graduated thumbwheel label 18. Thumbwheel label 18 is graduated by regularly spaced angular intervals and marked by numerical indicia. Each of the numerical indicia corresponds to one of the plurality of receivers. Window 20 is sized to allow visual inspection of a single graduation and associated indicium.

Push-to-make switch 27 is biased to an open position, and when actuated its closing of a circuit is momentary and non-latching. Push-to-make switch 27 comprises a switch cap 28 and a push-to-make switch label 29 attached to the switch cap 28. Push-to-make switch 27 is mounted on the transmitter printed circuit board 15 within the interior cavity defined by the transmitter casing. Switch cap 28 is formed in front surface 12 by partial circular cutout 30. Partial circular cutout 30 extends continuously for approximately 300 degrees forming two ends with the portion between the two ends remaining integral with the front surface allowing switch cap 28 to be pushed inwards relative to the front surface 12. Switch cap 28 abuts a plunger of push-to-make-switch 27. A prompting term such as ‘find’, ‘search’ or ‘locate’ may be printed on the switch label 29.

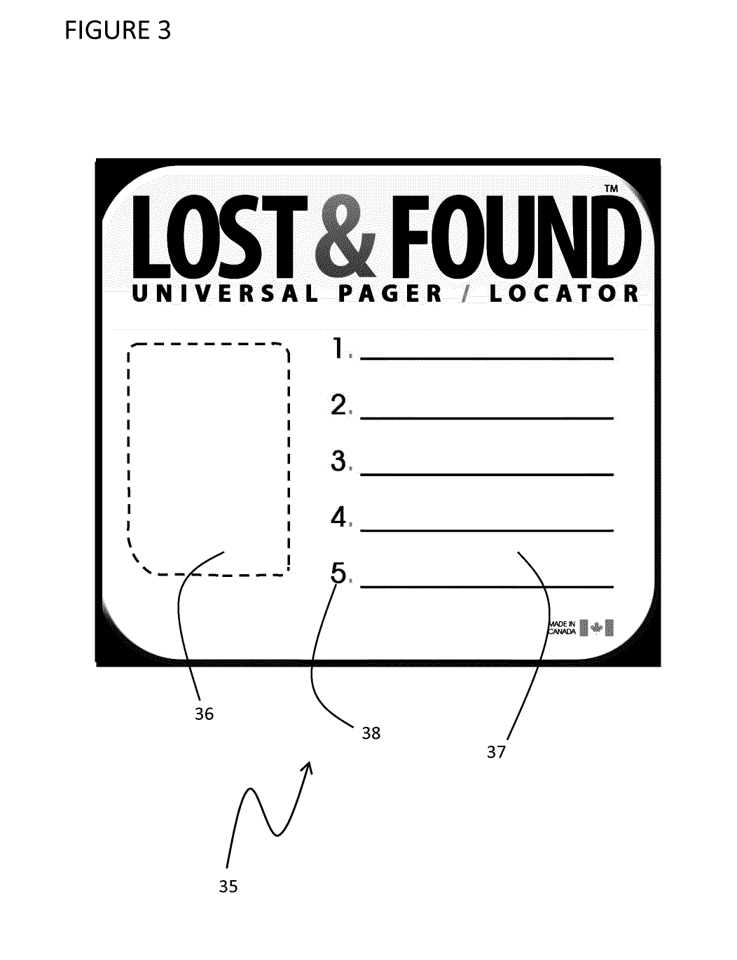

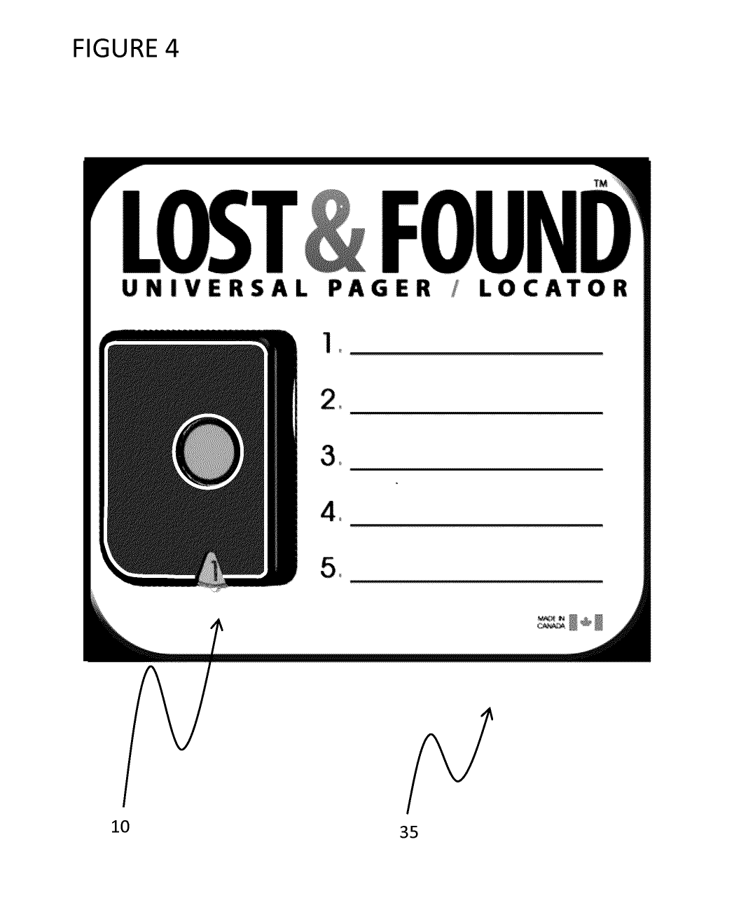

A transmitter docking pad 35 for reversible coupling of the transmitter 10 is shown in FIGS. 3 and 4. FIG. 3 shows the transmitter docking pad without the transmitter 10, with the broken line 36 indicating an area dedicated for reversible coupling of the transmitter. FIG. 4 shows the transmitter 10 coupled to the transmitter docking pad 35 at the area marked by broken line 36. Coupling the transmitter to its docking pad mitigates a risk of misplacing the transmitter.

The transmitter docking pad comprises, a front surface, a back surface, at least a portion of the front surface being a dry erase surface 37, and optionally a fastener such as an adhesive, a clip, a magnet or a clamp attached to the back surface. Dry erase surface 37 is compatible with conventional dry erase markers such as Expo markers (Newell Rubbermaid Inc., Freeport, Ill., USA), and the dry erase marker's ink is removable from the dry erase surface with a dry soft material. The dry erase surface 37 is marked with numerical indicia 38 that correspond to the numerical indicia marked on the thumbwheel label 18, and with numerical indicia marked on each one of a plurality of receivers. An identifier for an object coupled to a receiver designated by the numerical indicia can be manually written next to each numerical indicium on dry erase surface 37. Typically, the numerical indicia 38 are permanently marked. The object identifiers are erasably written on the dry erase surface 37 using dry erase markers. The combination of marking the dry erase surface 37 and selecting a position of the rotary switch 16 provides a power efficient method of organizing and interrogating a plurality of receivers, each coupled to a different targeted object.

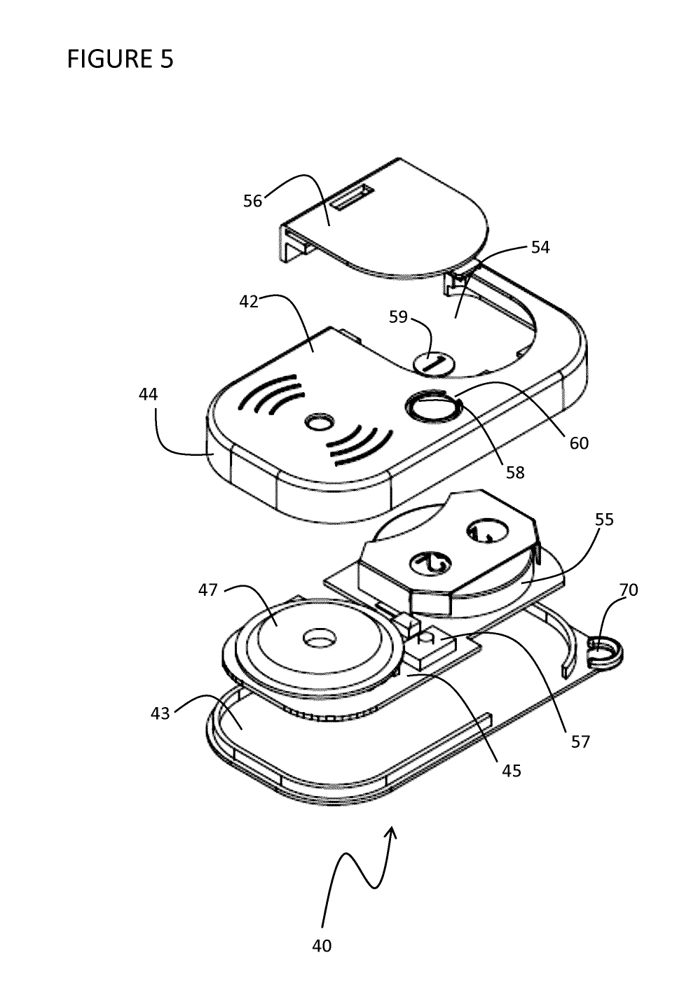

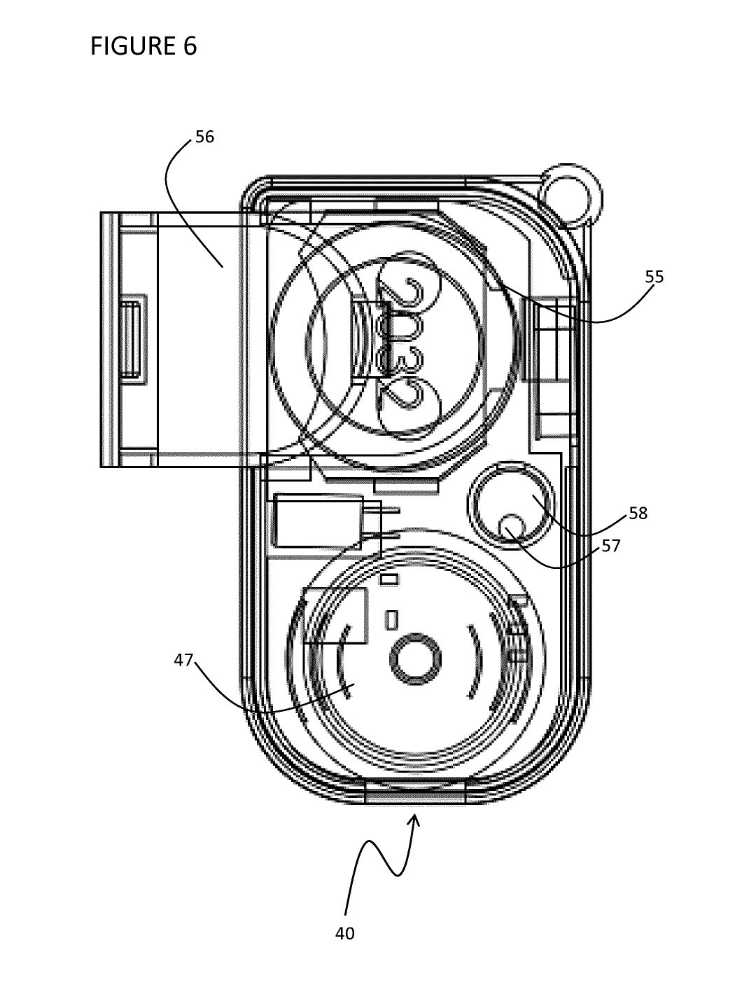

FIG. 5 shows an exploded view of a receiver 40 and FIG. 6 shows a front plan view of the receiver. The receiver 40 comprises a casing with a front surface 42 and a back surface 43 joined by circumferential sides 44 defining an interior cavity between the front surface and the back surface. Electronic components for receiving and decoding an RF modulated coded signal and emitting an audible indicator are mounted within the interior cavity of the casing. The components include: a receiver printed circuit board 45; a receiver antenna (not shown); a receiver microcontroller (not shown); an RF receiver (not shown); a buzzer 47; a receiver battery 55; and a push-to-break switch 57.

The receiver antenna captures the modulated carrier frequency signal emitted by the transmitter 10. The receiver antenna is communicative with the RF receiver. The RF receiver demodulates the modulated carrier frequency signal into a serial coded waveform. The RF receiver is communicative with the receiver microcontroller which decodes the serial coded waveform and determines whether to send a square wave to activate buzzer 47. The receiver printed circuit board 45 provides a surface for mechanically supporting a plurality of conductive pathways or tracks for electrically connecting electronic components of the receiver including the receiver antenna (not shown), the receiver microcontroller (not shown), the RF receiver (not shown), the buzzer 47; the receiver battery 55; and the push-to-break switch 57. Push-to-break switch 57 controls the pathway for the receiver battery 55 to provide power to the electronic components of the receiver 40. Receiver battery 55 is accessible through an aperture 54 formed in front surface 42. A receiver battery cap 56 covering the aperture 54 is reversibly coupled to the front surface 42, with removal of the receiver battery cap 56 allowing access to the receiver battery 55 for inspection or replacement. Providing a receiver battery cap on the front surface allows for battery replacement to occur without mechanical disruption of a coupling between the back surface of the receiver and a target object.

Push-to-break switch 57 is biased to a closed position, and when actuated its opening of a circuit is momentary and non-latching. Push-to-break switch 57 comprises a push-to-break switch cap 58 and a push-to-break switch label 59 attached to the switch cap 58. Push-to-break switch 57 is mounted on the receiver printed circuit board 15 within the interior cavity defined by the receiver casing. Switch cap 58 is formed in front surface 42 by partial circular cutout 60. Partial circular cutout 60 extends continuously for approximately 300 degrees forming two ends with the portion between the two ends remaining integral with the front surface allowing switch cap 58 to be pushed inwards relative to the front surface 42. Switch cap 58 abuts a plunger of push-to-break switch 57. A numerical indicium correlated with the numerical indicia of the thumbwheel label of the transmitter and the dry erase surface of the transmitter docking pad may be printed on switch label 59. Alternatively or additionally, a descriptive term such as ‘reset’ may be printed on the switch label 59. Optionally, a dry erase surface may be attached to each receiver casing to label a descriptive identifier of the target object.

Each receiver may be coupled to a target object using any convenient reversible or permanent fastener including, for example, adhesive solution, adhesive strips, magnets, pile fasteners such as Velcro, snap buttons, clips, clamps, hooks, and the like. An aperture 70 is defined at the perimeter of the back surface 43 to allow for quick coupling to key rings or hooks.

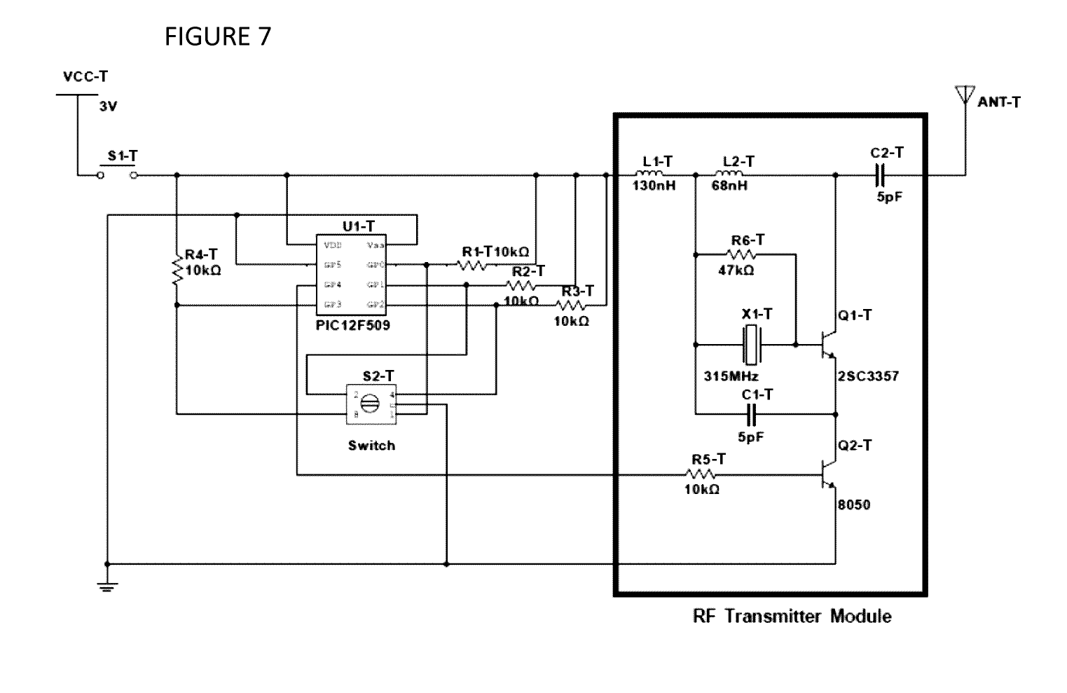

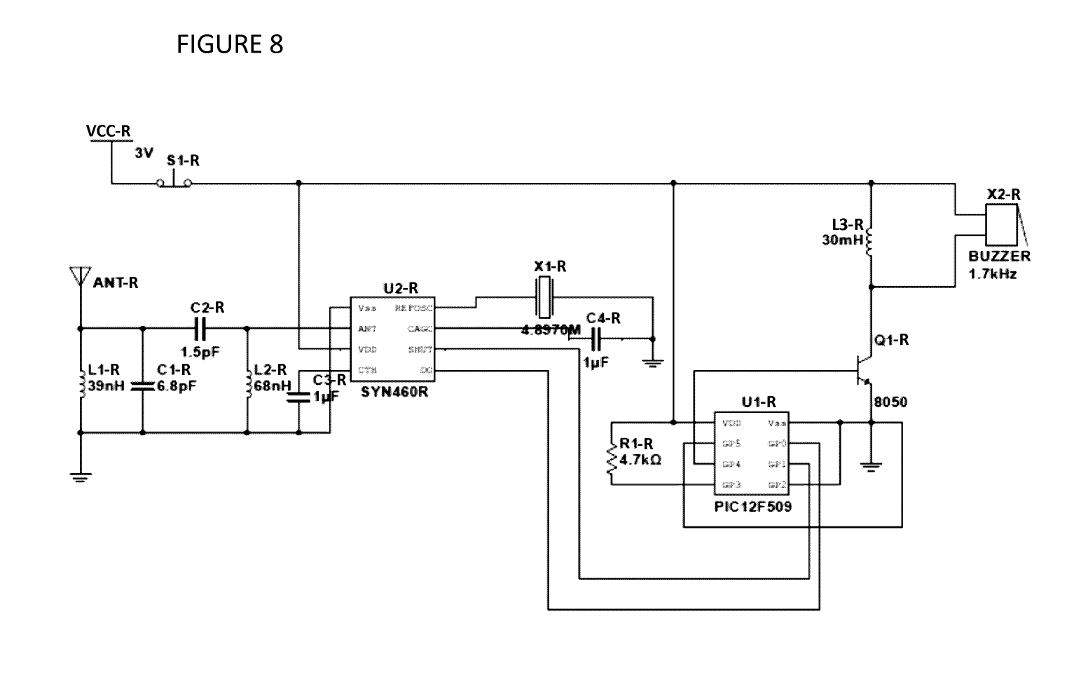

FIG. 7 shows a schematic diagram of the electronic circuitry of the transmitter 10 with description provided in Table 1. FIG. 8 shows a schematic diagram of the electronic circuitry of the receiver 40 with description provided in Table 2.

TABLE 1
Description of the transmitter schematic shown in FIG. 7.

| Reference | Name | Function |
|---|---|---|
| VCC-T | CR2032 Battery | Power supply for the transmitter. |
| S1-T | Push Button, | Push-to-make switch to activate the |
| | Normally Open | transmitter. |
| S2-T | Rotary Switch | Rotary switch to select a digital code |
| | | corresponding to a receiver, and to |
| | | send the digital code to micro- |
| | | controller (BCD code). |
| U1-T | IC, PIC12F509 | Microcontroller to encode address |
| | | pins into a serial coded waveform |
| | | suitable for RF modulation. |
| R1-T | Resistor, 10k | 4 pullup resistors to make the address |
| R2-T | Resistor, 10k | input high if ground is not connected |
| R3-T | Resistor, 10k | to the microcontroller address pin. |
| R4-T | Resistor, 10k | |
| L1-T | INDUCTOR, 130 nH | Inductor for Amplitude-shift keying |
| L2-T | INDUCTOR, 68 nH | (ASK) modulator. |
| C1-T | CAPACITOR, 5 pF | A Filter. Only AC can go through. |
| C2-T | CAPACITOR, 5 pF | |
| X1-T | Crystal Oscillator, | Generates a carrier frequency for |
| | SAW, 315 MHz | ASK modulation. |
| R5-T | RESISTOR, 10 kΩ | Sets the current to an operating range |
| | | of transistor Q2. |
| R6-T | RESISTOR, 47 kΩ | Sets the current to an operating range |
| | | of transistor Q1. |
| Q2-T | Transistor, NPN, | Amplifies a signal sent from |
| | 8050 | PIC12F509 |
| Q1-T | Transistor, NPN, | Modulates the carrier frequency to |
| | 2SC3357 | produce a coded signal |
| ANT-T | Antenna | Antenna to emit modulated radio |
| | | frequency |

TABLE 2
Description of the receiver schematic shown in FIG. 8.

| Reference | Name | Function |
|---|---|---|
| VCC-R | CR2032 Battery | Power supply for the receiver. |
| S1-R | Push Button, | Push-to-break switch to reset the |
| | Normally Closed | receiver. |
| L1-R | INDUCTOR, 39 nH | To match ANT pin, a 50 Ohms L- |
| C1-R | CAPACITOR, 6.8 pF | type circuit can be connected to the |
| C2-R | CAPACITOR, 1.5 pF | ANT pin of SYN460R RF receiver. |
| L2-R | INDUCTOR, 68 nH | Acts as a band pass filter passing |
| | | frequency around 315 MHz and |
| | | rejecting frequencies outside that |
| | | range. |
| C3-R | CAPACITOR, 1 μF | Selects data-slicing-level time |
| | | constant in SYN460R RF receiver. |
| C4-R | CAPACITOR, 1 μF | CTH capacitor. Extraction of the dc |
| | | value of the demodulated signal for |
| | | purposes of logic-level data slicing |
| | | is accomplished using the external |
| | | threshold capacitor CTH. |
| L3-R | Inductor, 30 mH | Increases the voltage between two |
| | | pins of the buzzer. |
| X1-R | Crystal Oscillator, | A reference oscillator for 315 MHz |
| | 4.8970 MHz | transmitting frequency. Timing and |
| | | tuning operations on the SYN460R |
| | | are derived from the internal |
| | | colpitts reference oscillator. |
| X2-R | BUZZER | An audio indicator. |
| U1-R | PIC12F509 | 1. To generate a square wave to keep |
| | | syn460R in sleep mode for 2.3 s, and |
| | | then fully operation mode for 40.1 |
| | | ms. |
| | | 2. To decode a serial code into a code |
| | | word that contains an address. The |
| | | decoded address is compared with the |
| | | address set in the firmware. If address |
| | | matches the code word, PIC12F509 |
| | | will send the square wave to the |
| | | buzzer. |
| R1-R | Resistor, 4.7k | To decrease the current through GP3 |
| | | of PIC12F509. |
| Q1-R | Transistor, NPN, | To amplify the square wave to the |
| | 8050 | buzzer. |
| U2-R | SYN460R | SYN460R is an ASK RF receiver. It |
| | | demodulates the RF signal into a |
| | | serial coded waveform, and sends the |
| | | serial coded waveform to the micro- |
| | | controller. |
| ANT-R | Antenna | Antenna to receive modulated RF |

In use, the object locator system described above provides a convenient and efficient mechanism for tracking misplaced objects. The transmitter of the object locator system is reversibly mounted on the transmitter docking pad. The transmitter docking pad may be mounted or kept unattached at a central location. A central location is generally a high visibility area for a particular application. For example, in a general household application targeting a variety of objects, a central location may include a refrigerator, a kitchen counter, a desk, or a bedside table. In a more specific application, such as a carpenter keeping track of tools, an example of a central location includes the carpenter's work bench or tool box. The transmitter docking pad may be mounted to a base surface using any convenient fasteners including adhesive solution, adhesive strips, magnets, pile fasteners such as Velcro, snap buttons, clips, clamps, hooks, and the like. In addition, apertures may be formed at or near the perimeter of the transmitter docking pad to receive nails, screws, tacks, pins, hooks and the like for mounting purposes.

The transmitter can emit a plurality of coded signals, a single coded signal can be selected using the rotary switch, and each coded signal is capable of triggering an audible indicator in one of a plurality of receivers. Each one of the plurality of receivers is attached to a separate targeted object. Indicium designating each receiver is correlated with indicia on the thumbwheel actuator of the rotary switch and indicia marked on the dry erase board. Typically, the correlated indicia will be graphical, numerical, alphabetical or any combination thereof. For example, a receiver having a label with the number 1 is correlated with a graduated position marked by the number 1 on the thumbwheel actuator of the rotary switch of the transmitter, and with the number 1 marked on the dry erase surface of the transmitter docking pad.

Whenever a receiver is attached to a targeted object, an object identifier is marked on the dry erase surface beside the appropriate correlated indicium. Accordingly, if the targeted object is misplaced a user can locate the targeted object by selecting the appropriate correlated indicium on the thumbwheel actuator, pressing the push-to-make switch to activate the transmitter to emit a coded interrogation signal, and tracking the audible indicator triggered in the receiver recognizing the coded interrogation signal. The audible indicator remains active until the user locates the activated receiver and attached object, and resets the receiver to silence the audible indicator by pressing the push-to-break switch of the receiver.

Several advantages of the object locator system are apparent from its use. A few illustrative advantages are provided here.

For example, the single push-to-make switch and the single rotary switch of the transmitter provide a distinct division of structure correlated to function that can be quickly and intuitively learned by the user. Transmitter designs with multiple push buttons, one for each receiver can be intimidating and/or confusing to the user, particularly for locator systems having greater than four receivers.

A transmitter with multiple push buttons increases the risk of unintentionally pushing the wrong button resulting in lost time due to following the audible indicator of a receiver attached to an unintended target object. Providing a single rotary switch focuses the user to correctly select the position of the rotary switch that correspond to the intended target object before activating the transmitter by pressing the push-to-make switch.

The rotary switch facilitates scale-up of the number of receivers that can be interrogated by a single transmitter, as rotary switches having up to 48 positions are conventionally available. Thus, the object locator system is readily scalable for receiver sets that range in number between 4 receivers and 48 receivers. In contrast, when considering prior art models, scale-up of a multiple push button transmitter design to greater than a 4 receiver set results in a confusing array of push buttons for the user, prone to mistaken selection of an unintended target object.

The multiple position rotary switch is power efficient as the intended receiver and its attached target object may be preselected by manipulating the thumbwheel in the absence of electrical current. The dry erase surface cooperates with the rotary switch to achieve a power efficient result, as the markings on the dry erase surface provide a legend for correlating a targeted object with each position of the multiple position rotary switch.

The transmitter docking pad and its dry erase surface cooperate to decrease the risk of misplacing the transmitter. The front surface area of the transmitter docking pad is typically more than double the size of the front surface area of the transmitter. Maintaining a coupling between the transmitter and the transmitter docking pad decreases a risk of misplacing the transmitter due to the increased size of the transmitter docking pad. Additionally, the inclusion of the dry erase surface as a portion of the front surface of the transmitter docking pad provides a powerful incentive for the user to maintain the coupling of the transmitter to the transmitter docking pad, as the markings on the dry erase surface provide a legend for correlating a targeted object with each position of the multiple position rotary switch.

An illustrative embodiment of the object locator system and a few variants are described above. Several examples of variants and modifications now follow.

The object locator system is intended to be a power efficient system, and therefore may optionally include various combinations of power conserving features. Independent of each other, both the multiple-position rotary switch and the dry erase surface are power conserving features. Together they cooperate to allow a quick and accurate selection of a position of the rotary switch in the absence of electrical current.

Another power conserving feature that may be optionally included in the object locator system is a duty cycle for the plurality of receivers. The receiver microcontroller generates a rectangular wave duty cycle controlling sleep and operational modes. Table 2 specifies a duty cycle of 2.3 seconds for sleep (off) mode and 40.1 milliseconds of operational (on) mode. Other duty cycles may be used including, for example, 10 seconds to 0.1 seconds or 5 seconds to 0.1 seconds. Typically, the on/off duty cycle will be less than 1:20, 1:30, 1:40, 1:50, 1:60, 1:70, 1:80, 1:90 or less than any ratio therebetween. Whichever duty cycle is chosen, the length of time that the transmitter emits the coded interrogation signal will typically be equal to or longer than the time of the sleep (off) mode.

Another power conserving feature is the absence of an alphanumerical electronic visual display. The transmitter will not include an electronic visual display of alphanumerical characters, such as electroluminescent, LCD, LED, DLP and the like. Indicator lights may be tolerated, for example, low battery indicators, transmitter activation indicator, and the like.

Another power conserving feature is optional intermittent timing of the audible indicator of the receivers. Once a receiver recognizes a coded interrogation signal an audible indicator may be triggered at intermittent bursts, for example, 50 milliseconds of a tone burst per second, 50 milliseconds per 2 seconds, 100 milliseconds per 2 seconds, 100 milliseconds per 3 seconds, etc. Typically, the tone burst can range from 20 milliseconds to 500 milliseconds. Typically, silent intervals between the bursts can range from 0.3 seconds to 5 seconds. The timing of audible indicator tone bursts may be regulated by the receiver microcontroller.

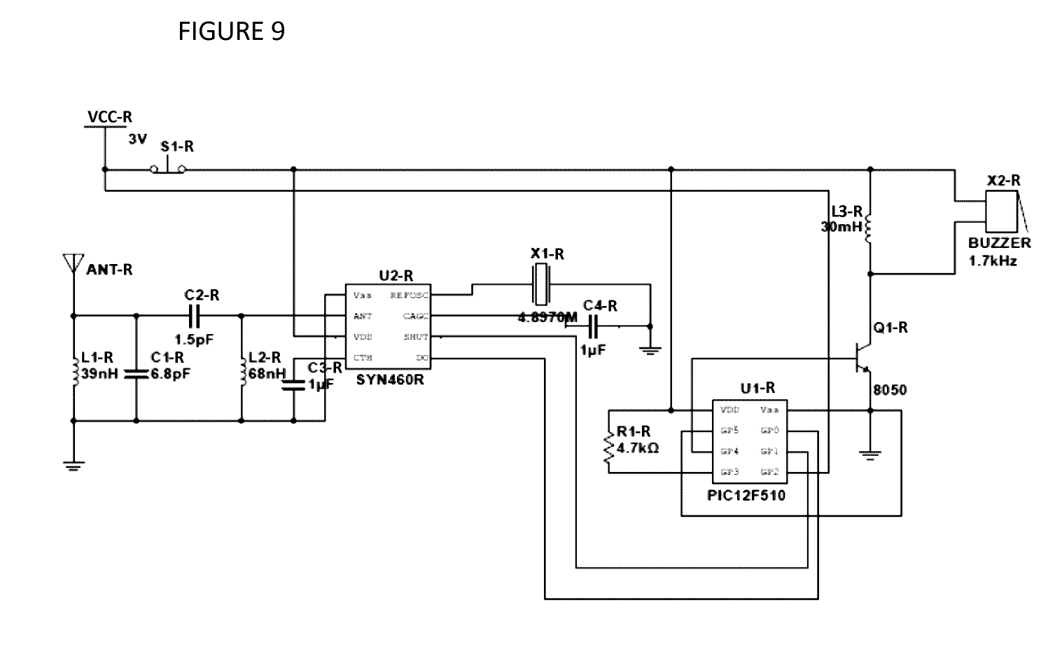

A further power efficiency feature is optional circuitry that detects a predetermined low level of receiver battery power and triggers the audible indicator. This feature does not conserve power, but increases efficiency in that it allows the user to take advantage of battery life, without risking an inactive receiver and without requiring proactive replacement of a battery that may still have sufficient charge for proper receiver function. FIG. 9 shows a circuitry schematic of a receiver comprising a low battery indicator with the use of a PIC12F510 micro-controller instead of PIC12F509 (shown in FIG. 8). The PIC12F510 can be used to detect low battery power due to its analog-to-digital converter (ADC) function, while the PIC12F509 does not possess an ADC function. Using PIC12F510 an ADC pin can be connected to the battery to measure the voltage of battery. As battery life extends, voltage is decreased (as shown for example in FIG. 10). The PIC12F510 can convert an analog voltage measurement value to a digital value, and compare the digital value with a predetermined reference value. If the measured value is lower than the predetermined reference value (for example 2.4V for a 3V battery, 11001100 in binary code), PIC12F510 sends a square wave to the audible indicator. The predetermined reference value may be any value compatible with the type of battery, but will typically be set at 10% to 50% lower than the voltage of a new battery. Illustrative examples of predetermined reference values include 15% to 45%, 15% to 40%, 20% to 40% or 20% to 35% lower than the voltage of a new battery. The PIC12F510 is not critical, and more generally a use of a micro-controller is not critical. If desired the PIC12F510 may be substituted with any circuitry capable of ADC function and reference value comparison.

The audible indicator tone burst pattern may be specified in the programmable code of PIC12F510. The audible indicator tone burst pattern to indicate low battery power will be distinct from the intermittent tone burst pattern upon activation due to an interrogation signal. In particular, the silent intervals for the low battery indication will be longer than the silent intervals for the activation indication, so as to mitigate the risk of the low battery indication draining battery without being noticed by the user. Typically, the low battery indicator will be timed so as to continue for greater than 24 hours, 48 hours, 72 hours or greater than any number therebetween. The low battery indicator may readily be timed to continue for greater than 7 days without fully draining the battery. To indicate low battery power, typical tone bursts can range from 20 milliseconds to 200 milliseconds. Typically, silent intervals between each tone burst can range from 5 seconds to 60 minutes. Typically, the frequency of the bursts will be timed to be less than ⅕ seconds, 1/10 seconds, 1/20 seconds, 1/30 seconds, 1/40 seconds, 1/50 seconds, 1/60 seconds or less than any number therebetween.

Use of a single micro-controller and a single audible indicator to provide notice of both low battery power and activation by an interrogation signal is another example of an optional power efficient feature. The choice of micro-controller and/or audible indicator may vary depending upon application criteria. Suitable micro-controllers other than PIC12F509 or PIC12F510 are readily available. Indeed, the micro-controller may be replaced altogether, for example, with encoder/decoder pairs such as PT2262/PT2272. Similarly, many different audible indicators such as piezoelectric buzzers are readily available. The transmitter may similarly be equipped with a low battery indicator as desired.

The multiple-position rotary switch, in addition to providing a power conserving advantage, also provides an organizational advantage. The codes for triggering an audible indicator in one a plurality of receivers can be organized with a single switch. The angular spacing provided by the thumbwheel actuator of the rotary switch allows the graduated indicia to be distinctly marked so that the different positions of the rotary switch are readily apparent to the user. Furthermore, the user is able to readily observe when a graduated indicium is at right angles with transmitter casing, particularly when the switch incorporates a detent mechanism. The thumbwheel actuator also lends itself to being viewed through a window in the casing of the transmitter such that only a single graduated indicium can be viewed through a window. In comparison, a multiple-position linear switch requires a longer dimension for sets of more than 4 receivers and is prone to positioning the switch actuator beside the intended switch position. For a linear switch, all graduated indicia are at the same angle and therefore the visual effect of an indicium moving into a right angle orientation is not possible. However, from a power conservation perspective, both a multiple-position rotary switch and a multiple-position linear switch are acceptable. Therefore, if the organizational advantage of the multiple-position rotary switch is not desired it may be substituted with the multiple-position linear switch or any other conventional multiple-position switch.

The dry erase surface provides both a power conserving advantage and an organizational advantage. When the object locator system includes a transmitter docking pad at least a portion of the front surface of the docking pad will be a dry erase surface. The dry erase surface may cover any convenient sized area. Typically, the area of the dry erase surface can be equal to or greater than the area of the front surface of the transmitter. Typically, the dry erase surface can cover more than 20%, 30%, 40%, 50%, 60% or any percentage therebetween of the front surface of the transmitter docking pad.

The dry erase surface (or whiteboard surface) may be any coating, material, laminate, and the like that is compatible with dry erase markers, such as markers containing an ink composition comprising a silicone compound or such as markers produced by Expo (Newell Rubbermaid Inc., Freeport, Ill., USA). The silicone compound, for example a silicone oil or a silicone surfactant, can function as a releasing agent. Dry erase inks that do not include silicone compounds are also known as described for example in U.S. Pat. No. 5,324,764 (issued 28 Jun. 1994). The compatibility of the dry erase surface and the dry erase markers is evident by removing markings of the dry erase markers from the dry erase surface using a dry material, such as a dry cloth or paper tissue. Further examples of dry erase ink and dry erase surfaces may be found in U.S. Pat. No. 3,949,132 (issued 6 Apr. 1976), U.S. Pat. No. 4,996,110 (issued 26 Feb. 1991), U.S. Pat. No. 5,217,255 (issued 8 Jun. 1993), U.S. Pat. No. 5,716,685 (issued 10 Feb. 1998), U.S. Pat. No. 5,919,858 (issued 6 Jul. 1999) or U.S. Pat. No. 7,713,357 (issued 11 May 2010).

The dry erase surface can also be coupled to the transmitter casing, and may be useful in applications where the transmitter is used without a docking pad. For example, a dry erase surface label may be attached to a front or back surface of the casing. A potential problem with this arrangement is that markings made by dry erase markers on the dry erase surface are susceptible to being erased as the user inserts, removes or maintains the transmitter within common enclosures such as pockets, purses, backpacks, and the like. To avoid this problem the dry erase surface may be attached to a panel that is coupled to the transmitter casing, the panel moveable from a closed position to an open position. The dry erase surface is typically not observable when the panel is in the closed position. However, a transparent window such as formed using a transparent plastic may be formed in the transmitter casing to allow observation of the dry erase surface when the panel is in the closed position. The panel may be coupled to the transmitter casing using any convenient mechanism, for example, the coupling may be slidable, hinged, pivotable with at least a 90 degree rotation, telescopic or retractable. Furthermore, the panel may be biased to the closed position using any conventional spring mechanism. The area of the dry erase surface attached to the panel may be any convenient size, but typically will be less than the area of the front surface of the transmitter casing by 5%, 10%, 20%, 30%, 40%, 50% or any percentage therebetween.

A dry erase surface may be similarly coupled to receivers as desired.

The transmitter and transmitter docking pad coupling shown in FIG. 4 can be reversibly coupling with a pair of pegs extending from the back surface of the transmitter engaging mating apertures or depressions formed in the transmitter docking pad. The fastener used to couple the transmitter to the transmitter docking pad is not critical. The coupling of the transmitter to the transmitter docking pad may be through any convenient reversible or permanent fastener. Similarly, if a coupling of the transmitter docking pad to a base surface is desired, then the coupling may be achieved through any convenient reversible or permanent fasteners. Similarly, coupling of the receiver to a target object may be achieved through any convenient reversible or permanent fastener. Examples of useful fasteners include adhesive solution, adhesive strips, magnets, pile fasteners such as Velcro, snap buttons, clips, clamps, hooks, pegs, screws, tacks, pins and the like.

The transmitter docking pad may be any convenient size or shape to support the coupled transmitter. Typically, the transmitter docking pad will be a substantially planar sheet defined by opposing front and back surfaces. The area of the front surface of the transmitter docking pad will be greater than the area of the front surface of the transmitter. Typically, the area of the front surface of the transmitter docking pad will be greater than the area of the front surface of the transmitter by a multiple of greater than 1.4, 1.5, 1.6, 1.7, 1.8, 1.9, 2.0, 2.1, 2.2, 2.3, 2.4, 2.5 or a multiple greater than any number therebetween.

The transmitter docking pad may optionally comprise a retainer for holding a dry erase marker. Any conventional retainer may be used such as a clip, a clamp, a shelf, a recess or depression, a sleeve, a strap, a tether, an elastic band, a pile fastener, a magnet and the like.

In applications where electronic tracking of the transmitter is desired a second transmitter capable of emitting a single coded interrogation signal may be permanently attached to the docking pad with a corresponding receiver and audible indicator incorporated into the transmitter.

The switch caps for push-to-make switch of the transmitter and push-to-break switch of the receiver are formed within the front surface by partial cutouts of the front surface to create a tab integral with the front surface that abuts the plunger of the switch. Alternatively, a switch may be used that includes a cap and a full cutout of the front surface can form an aperture to access the cap of the switch. The construction of the push-to-make switch or the push-to-break switch is not critical, and any convenient model may be used.

In the object locator system, modulation of a carrier frequency to represent a serial coded wave form and generate a coded interrogation signal and its subsequent demodulation may be through any convenient digital modulation scheme. Amplitude-shift keying (ASK), frequency-shift keying (FSK), and phase-shift keying (PSK) are examples of useful digital modulation schemes. ASK refers to a type of amplitude modulation that assigns bit values to discrete amplitude levels. The carrier signal is then modulated among the members of a set of discrete values to transmit information. ASK provides power conserving advantages. FSK refers to a type of frequency modulation that assigns bit values to discrete frequency levels. FSK is divided into noncoherent and coherent forms. In noncoherent forms of FSK, the instantaneous frequency shifts between two discrete values termed the “mark” and “space” frequencies. In coherent forms of FSK, there is no phase discontinuity in the output signal. PSK in a digital transmission refers to a type of angle modulation in which the phase of the carrier is discretely varied—either in relation to a reference phase or to the phase of the immediately preceding signal element—to represent data being transmitted. For example, when encoding bits, the phase shift could be 0 degree for encoding a “0,” and 180 degrees for encoding a “1,” or the phase shift could be −90 degrees for “0” and +90 degrees for a “1,” thus making the representations for “0” and “1” a total of 180 degrees apart. Some PSK systems are designed so that the carrier can assume only two different phase angles, each change of phase carries one bit of information, that is, the bit rate equals the modulation rate.

Any frequency may be used as permitted or regulated by government broadcast standards, including any permitted frequency or frequencies in a range of 100 MHz to 3000 MHz. Other examples include 200 MHz to 1000 MHz or 300 MHz to 440 MHz.

The SYN460R RF receiver may be substituted with other radio frequency demodulator mechanisms that can demodulate a radio frequency input to produce a digital signal output. SYN460R is a wireless ASK/OOK (On-Off keyed) receiver chip, mainly used in the field of wireless RF remote control in an operating range of 300 to 440 MHz. Advantages of SYN460R include high sensitivity and low power consumption. In the 433 MHz environment, its sensitivity can reach −107 dBm (receiving sensitivity of −106 dBm at 315 MHz, −107 dBm at 433 MHz). The high sensitivity is useful for effective reception of a signal at longer physical separation from the transmitter. Its low power consumption is useful for extending battery life. In this regard, SYN460R has two useful features: (1)—a Shutdown pin, which may be used to turn the device off for duty-cycled operation, and (2) a Wake-up output, which provides an output flag indicating when an RF signal is present. Examples of SYN460R power consumption in different modes include 3.7 milliAmp (315 MHz, fully working), 0.9 microAmp (shutdown mode), and 370 microAmp (315 MHz, 10:1 duty cycle). The SYN460R can readily be substituted with a SYN480R RF receiver.

The features of a manually actuated multiple position switch, a dry erase surface and a transmitter docking pad, either independent of each other or in any combination may be advantageously incorporated into most existing object locator systems, particularly those with receiver sets ranging from 4 to 50 receivers, to provide a power-efficient and/or organizational advantage. Cooperative effects of various combinations of these features have been described above.

Still further equivalents, variants, modifications or combinations thereof will be apparent to the person of skill in the art.

1-28. (canceled)

29. An object locator system, comprising:
a transmitter comprising circuitry to generate and emit a radio frequency interrogation signal representing one of a plurality of unique codes;
a plurality of receivers each recognizing one of the plurality of unique codes and each comprising an audible indicator triggered by recognition of the unique code in the interrogation signal; and
a transmitter docking pad having a front surface and a back surface, the front surface of the transmitter docking pad having a greater area than a front surface of the transmitter, the front surface of the transmitter docking pad comprising a dry erase surface compatible with dry erase markers.

30. The object locator system of claim 29, wherein the transmitter does not include an electronic alphanumerical visual display.

31. The object locator system of claim 30, wherein more than 40% of the front surface of the transmitter docking pad is covered by the dry erase surface.

32. The object locator system of claim 30, wherein the transmitter is reversibly coupled to the transmitter docking pad.

33. The object locator system of claim 30, wherein the transmitter docking pad further comprises a retainer for holding a dry erase marker.

34. The object locator system of claim 30, wherein the back surface of the transmitter docking pad further comprises a reversible fastener for reversibly coupling the transmitter docking pad to a base surface.

35. The object locator system of claim 30, further comprising a second dry erase surface coupled to the transmitter, the second dry erase surface coupled to a panel that is coupled to a casing of the transmitter, the panel moveable from an open position to a closed position.

36. The object locator system of claim 30, wherein the plurality of receivers further comprise a low battery detector circuit that triggers the audible indicator at a frequency of less than one burst per five seconds.

37. The object locator system of claim 30, wherein the plurality of receivers further comprise a push-to-break reset switch.

38. An object locator system, comprising:
a transmitter comprising circuitry to generate and emit a radio frequency interrogation signal representing one of a plurality of unique codes, and a graduated multiple-position switch for selecting the one of the plurality of unique codes, the switch moveable from a first position to a second position in the absence of electrical current, each position providing one of the plurality of unique codes;
a plurality of receivers each recognizing one of the unique codes provided by the graduated multiple-position switch and each comprising an audible indicator triggered by recognition of the unique code in the interrogation signal; and
a transmitter docking pad having a front surface and a back surface, the front surface of the transmitter docking pad having a greater area than a front surface of the transmitter, the front surface of the transmitter docking pad comprising a dry erase surface compatible with dry erase markers.

39. The object locator system of claim 38, wherein the transmitter does not include an electronic alphanumerical visual display.

40. The object locator system of claim 39, wherein the graduated multiple-position switch is a multiple-position rotary switch.

41. The object locator system of claim 40, wherein the transmitter switches consist essentially of a single multiple-position rotary switch and a single push-to-make activation switch.

42. The object locator system of claim 40, wherein the multiple-position rotary switch comprises a thumbwheel actuator marked with graduated indicia.

43. The object locator system of claim 42, wherein the transmitter further comprises a casing, the casing defining a window sized to observe a single graduated indicium.

44. The object locator system of claim 40, wherein more than 40% of the front surface of the transmitter docking pad is covered by the dry erase surface.

45. The object locator system of claim 40, wherein the transmitter docking pad further comprises a retainer for holding a dry erase marker.

46. The object locator system of claim 40, wherein the back surface of the transmitter docking pad further comprises a reversible fastener for reversibly coupling the transmitter docking pad to a base surface.

47. The object locator system of claim 40, further comprising a second dry erase surface coupled to the transmitter, the second dry erase surface coupled to a panel that is coupled to a casing of the transmitter, the panel moveable from an open position to a closed position.

48. The object locator system of claim 40, wherein the plurality of receivers further comprise a low battery detector circuit that triggers the audible indicator at a frequency of less than one burst per five seconds.
